(19) United States
(12) Patent Application Publication
(10) Pub. No.: US 2017/0023065 A1
(43) Pub. Date: Jan. 26, 2017

(54) Rolling Bearing

(71) Applicant: JTEKT CORPORATION, Osaka-shi (JP)

(72) Inventors: Shigeo KAMAMOTO, Kashiwara-shi (JP); Junji MURATA, Kashiba-shi (JP); Yuki SHISHIHARA, Kashiwara-shi (JP); Kunishige NAKAZAWA, Itami-shi (JP)

(73) Assignee: JTEKT CORPORATION, Osaka-shi (JP)

(21) Appl. No.: 15/210,013

(22) Filed: Jul. 14, 2016

(30) Foreign Application Priority Data
Jul. 22, 2015 (JP) 2015-144857

(51) Int. Cl. F16C 33/78; F16C 19/06

(52) U.S. Cl. CPC F16C 33/7886; F16C 19/06

(57) ABSTRACT

A rolling bearing includes an inner ring, an outer ring, a plurality of balls, a cage that holds the balls, and a sealing device that is attached to each of opposite sides of the outer ring in an axial direction to prevent foreign matter from entering inside the bearing. A noise-reduction portion that attenuates sound inside the bearing is formed on at least one of a surface of the cage and a bearing inner-side surface of the sealing device.

### INCORPORATION BY REFERENCE

The disclosure of Japanese Patent Application No. 2015-144857 filed on Jul. 22, 2015 including the specification, drawings and abstract, is incorporated herein by reference in its entirety.

### BACKGROUND OF THE INVENTION

1. Field of the Invention

The present invention relates to a rolling bearing.

2. Description of Related Art

Rolling bearings are used for various industrial machines. A rolling bearing includes an inner ring, an outer ring, a plurality of rolling elements, and a cage. The rolling elements are interposed between the inner ring and the outer ring. The cage holds the rolling elements. When rolling bearings are used as bearings that support a motor included in a home appliance, for example, in order to suppress generation of operation noise, the rolling bearings are required to reduce noise generated due to rotation.

For example, Japanese Patent Application Publication No. 2008-208976 (JP 2008-208976 A) proposes a rolling bearing that aims to suppress generation of noise due to rotation. In this rolling bearing, an annular groove is formed in an unloaded area of a raceway surface of an outer ring, on that is not in contact with rolling elements (balls). An O ring as an elastic body is attached to this annular groove.

Noise generated by rotation of the rolling bearing can be reduced to some extent by improving accuracy of dimensions and surfaces of various parts such as the rolling elements, the raceway surface of an inner ring, and the raceway surface of an outer ring. However, there is a limit to the extent to which noise is attempted to be reduced by improving the accuracy of various parts constituting the rolling bearing, and such accuracy improvement leads to cost increase.

When an annular groove is formed in the raceway surface of an outer ring and an O ring is attached to this annular groove as in JP 2008-208976 A, additional processing of the annular groove is necessary. Since the O ring is required as an additional member, increases the number of components increases, which also increases costs.

### SUMMARY OF THE INVENTION

An object of the present invention is to provide a rolling bearing that can reduce noise while suppressing cost increase as small as possible.

According to an aspect of the present invention, a rolling bearing includes:

an inner ring; an outer ring: a plurality of rolling elements interposed between the inner ring and the outer ring; a cage that holds the rolling elements; and a sealing device that is attached to each of opposite sides of the outer ring in an axial direction to prevent foreign matter from entering inside the bearing. In the rolling bearing, a noise-reduction portion that attenuates sound inside the bearing is formed on at least one of a surface of the cage and a bearing inner-side surface of the sealing device.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view illustrating a rolling bearing according to one embodiment of the present invention;

FIG. 2 is an enlarged sectional view illustrating a recessed groove and part of a sealing device on one side of the bearing in an axial direction (left side in FIG. 1);

FIG. 3 is a diagram of a shield plate when viewed from the axial direction;

FIG. 4 is a sectional view of a noise-reduction portion taken along a virtual line along the circumferential direction in FIG. 3;

FIG. 5 is a perspective view illustrating part of the shield plate;

FIG. 6 is a sectional view illustrating a rolling bearing according to another embodiment;

FIG. 7 is a sectional view illustrating a modification of the rolling bearing depicted in FIG. 6;

FIG. 8 is a sectional view illustrating a rolling bearing according to another embodiment; and

FIG. 9 is a diagram of a cage holding balls when viewed from the axial direction.

### DETAILED DESCRIPTION OF EMBODIMENTS

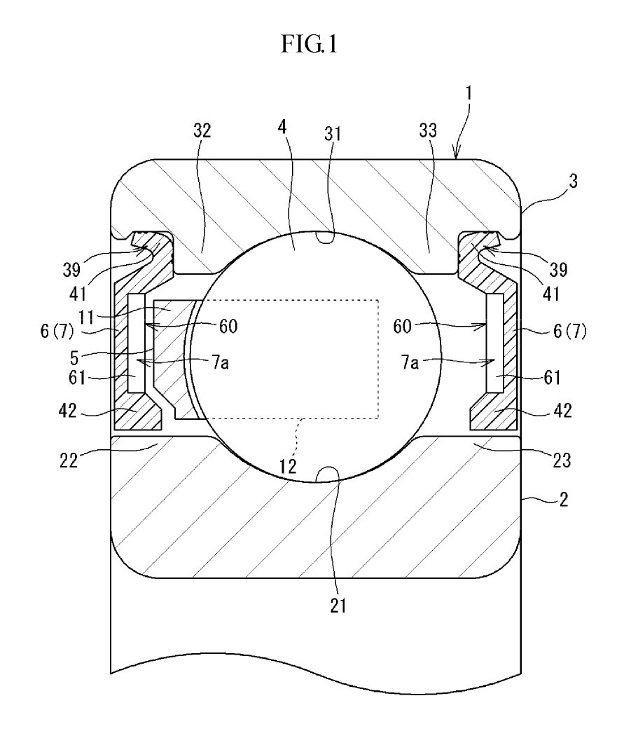

Embodiments of the present invention will now be described with reference to the drawings. FIG. 1 is a sectional view illustrating a rolling bearing according to one embodiment of the present invention. This rolling bearing 1 includes an inner ring 2, an outer ring 3, a plurality of rolling elements, an annular cage 5, and a sealing device 6. The outer ring 3 is disposed the radially outward of the inner ring 2.

The rolling elements are interposed between the inner ring 2 and the outer ring 3. The cage 5 holds the rolling elements. The rolling elements of the present embodiment are balls 4, and the rolling bearing 1 is a deep groove ball bearing.

The inner ring 2 is an annular member and, in the outer periphery thereof, an inner raceway groove 21 on which the balls 4 roll is formed. The inner ring 2 has a first shoulder portion 22 adjacent to one side of the inner raceway groove 21 in the axial direction and a second shoulder portion 23 adjacent to the other side of the inner raceway groove 21 in the axial direction.

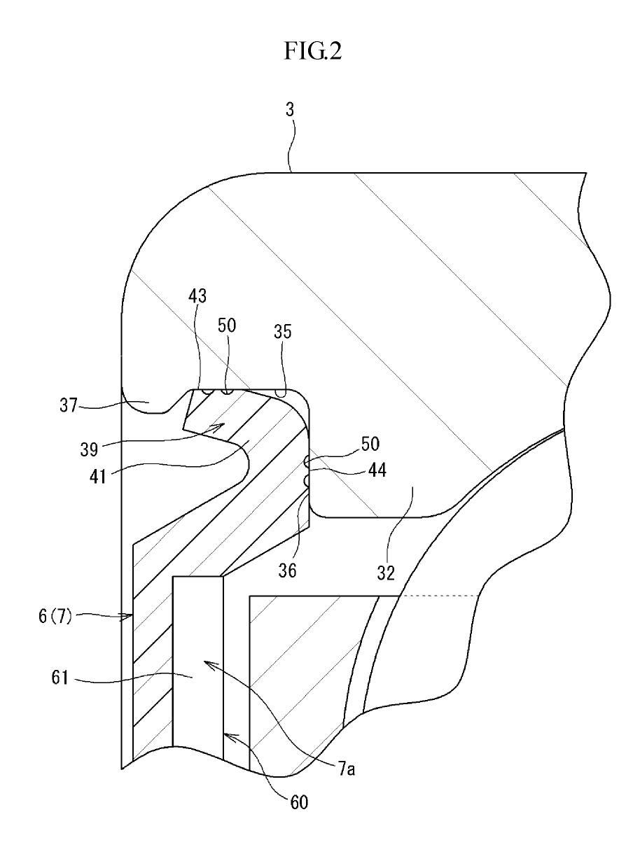

The outer ring 3 is an annular member and, in the inner periphery thereof, an outer raceway groove 31 on which the balls 4 roll is formed. The outer ring 3 has a first shoulder portion 32 adjacent to one side of the outer raceway groove 31 in the axial direction and a second shoulder portion 33 adjacent to the other side of the outer raceway groove 31 in the axial direction. The inner peripheral surface of the outer ring 3 has recessed grooves 39 formed on respective opposite sides of the outer ring 3 in the axial direction. A sealing device 6 is attached to each recessed groove 39. FIG. 2 is an enlarged sectional view illustrating the recessed groove 39 and part of the sealing device 6 on one side of the bearing 1 in the axial direction (left side in FIG. 1). The recessed groove 39 has a groove inner peripheral surface 35 that is directed (opposed) to the inner ring 2 and a groove side surface 36 that is directed (faces) outward in the axial direction.

The outer ring 3 has a protruding portion 37 that has a circular ring shape and protrudes radially inward from an end portion thereof in the axial direction. This protruding portion 37 prevents the sealing device 6 attached to the recessed groove 39 from becoming detached axially outward.

In FIG. 1, the balls 4 are interposed between the inner raceway groove 21 and the outer raceway groove 31, and when the rolling bearing 1 (inner ring 2) rotates, the balls 4 roll in the inner raceway groove 21 and the outer raceway groove 31. Each ball 4 is a steel member made of bearing steel, for example. The inner ring 2 and the outer ring 3 are each made of steel such as bearing steel or steel for machine structural use.

The cage 5 is what is called a snap cage, which includes an annular portion 11 and a plurality of cage bar portions 12. The annular portion 11 is positioned on one side of the bearing 1 in the axial direction with respect to the balls 4. The cage bar portions 12 extend from this annular portion 11 toward the other side of the bearing 1 in the axial direction. The annular portion 11 is a member having a circular ring shape, and is positioned between the shoulder portion 22 of the inner ring 2 and the shoulder portion 32 of the outer ring 3. A space that is between the cage bar portions 12 adjacent to each other in the circumferential direction and is on the other side of the bearing 1 in the axial direction with respect to the annular portion 11 serves as a pocket that accommodates each ball 4. A plurality of the pockets is formed along the circumferential direction, and the cage 5 can hold the balls 4 at intervals in the circumferential direction.

The cage 5 is made of resin (synthetic resin), and is produced by injection molding. The annular portion 11 and the cage bar portions 12 are integrally formed, so that the cage 5 consists of a single member. Herein, the cage 5 may be formed differently from the structure depicted in FIG. 1, and may also include a second annular portion on the other side of the bearing 1 in the axial direction, and a pair of the annular portions may be coupled together by the cage bar portions.

The sealing devices 6 are attached to the respective opposite sides of the outer ring 3 in the axial direction, and prevent external foreign matter from entering the inside of the bearing in which the balls 4 are provided. The sealing devices 6 have a function of preventing grease in the bearing from leaking outside. Each sealing device 6 having the structure depicted in FIG. 1 is an annular shield plate 7, and an outer peripheral portion (radially outer portion) 41 thereof is fitted into the corresponding recessed groove 39 of the outer ring 3, whereby the shield plate 7 is attached to the outer ring 3. Each inner peripheral portion (radially inner portion) 42 of the shield plate 7 faces the inner ring 2 (shoulder portion 22, 23) with a space interposed therebetween, and the inner peripheral portion 42 forms a labyrinth seal. The sealing device 6 (shield plate 7) on one side of the bearing 1 in the axial direction and the sealing device 6 (shield plate 7) on the other side of the bearing 1 in the axial direction have the same structure, but attachment orientations thereof are opposite. The recessed grooves 39 have cross-sectional shapes that are laterally symmetrical in the vertical cross-section, but otherwise identical.

Each shield plate 7 is made of resin (synthetic resin) such as polyphenylene sulfide resin or polyamide resin (PA66), and is produced by injection molding. As depicted in FIG. 2, the outer peripheral portion 41 of the shield plate 7 has two attachment surfaces 43, 44. In a state in which the shield plate 7 is attached to the recessed groove 39, the first attachment surface 43 is in contact with the groove inner peripheral surface 35 of the recessed groove 39, and the second attachment surface 44 is in contact with the groove side surface 36 of the recessed groove 39.

The protruding portion 37 of the outer ring 3 prevents the shield plate 7 from becoming detached axially outward as described above. The shield plate 7 is attached to the recessed groove 39 by snap-fitting. In other words, by elastically deforming the shield plate 7, the outer peripheral portion 41 can move over the protruding portion 37. In a state in which the shield plate 7 is attached to the recessed groove 39, the outer peripheral portion 41 is brought into contact with and fitted into the recessed groove 39 with a tightening margin. This enables the shield plate 7 to have a function of restraining displacement (vibration) of the outer ring 3 due to vibrations associated with rotation of the rolling bearing 1.

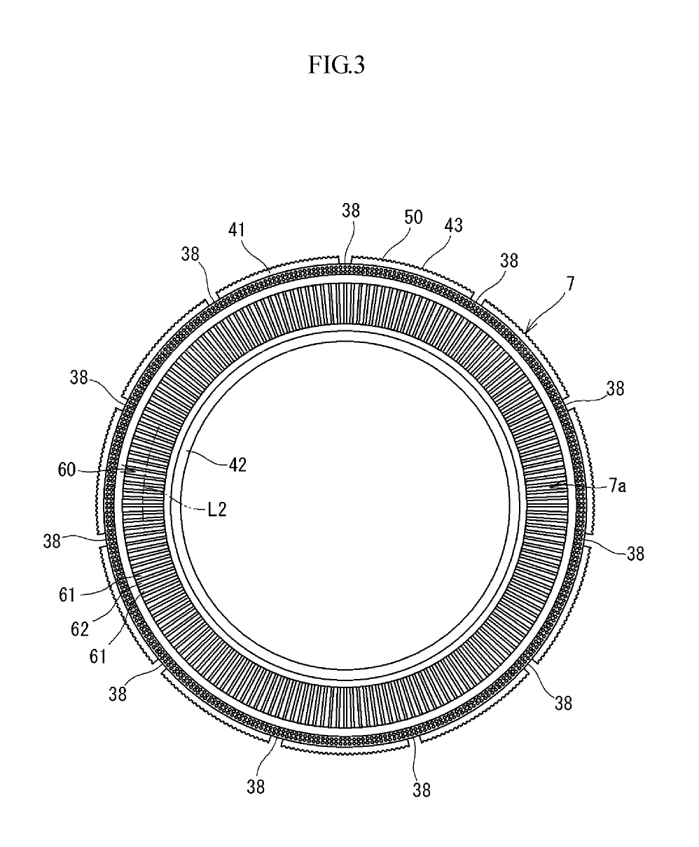

FIG. 3 is a diagram of the shield plate 7 when viewed from the axial direction. On the outer peripheral portion 41 of the shield plate 7, a plurality of notches 38 are formed. These notches 38 cause the outer peripheral portion 41 of the shield plate 7 to easily deform. This facilitates operation of attaching the shield plate 7 to the outer ring 3 by snap-fitting.

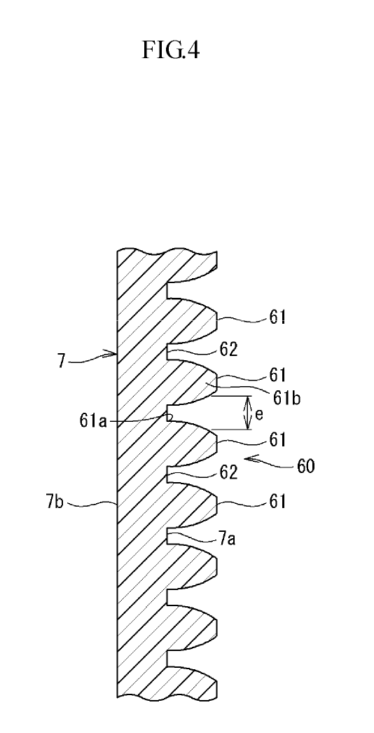

On a bearing inner-side surface 7a (hereinafter, also referred to as “inner side surface 7a”) of the shield plate 7 on which the balls 4 are provided, a noise-reduction portion 60 that attenuates noise inside the bearing is formed. FIG. 4 is a sectional view of the noise-reduction portion 60 taken along the virtual line L2 along the circumferential direction in FIG. 3. The inner side surface 7a of the shield plate 7 has an uneven shape, and this uneven shape attenuates noise inside the bearing. A bearing outer-side surface 7b of the shield plate 7 is a flat surface having an annular shape.

The following describes the noise-reduction portion 60 having this uneven shape in further detail. The noise-reduction portion 60 depicted in FIG. 4 has a plurality of projecting ridges 61, and the distance e between the adjacent projecting ridges 61 becomes shorter toward the bottom portion 61a of the projecting ridges 61. In this noise-reduction portion 60, sound inside the bearing that is incident on a first projecting ridge 61 is reflected toward a second projecting ridge 61 that is adjacent to the first projecting ridge 61. When this reflected sound is incident on the second projecting ridge 61, the sound is reflected toward the first projecting ridge 61. This reflected sound is again incident on (a different portion of) the first projecting ridge 61. The sound that is again incident on the first projecting ridge 61 is reflected toward the second projecting ridge 61. Such incidence and reflection is repeated, whereby the sound is absorbed (the sound is attenuated). Particularly in the noise-reduction portion 60 of the present embodiment, the distance e becomes shorter toward the bottom portion 61a. This structure produces an effect of trapping sound (adsorbing sound) by reflecting sound that is incident on distal end 61b side portions of the projecting ridges 61 toward the bottom portions 61a every time reflection is repeated.

The noise-reduction portion 60 is formed on the inner side surface 7a of each shield plate 7 as described above, so that vibrations (sound) generated in rolling contact portions between the inner raceway groove 21 and the balls 4 and between the outer raceway groove 31 and the balls 4, and in sliding contact portions between the cage 5 and the balls 4 are reduced by this noise-reduction portion 60, and noise transmitted from the outer ring 3 to the outside of the bearing can be reduced.

Furthermore, as depicted in FIG. 3, in the noise-reduction portion 60 of the present embodiment, a plurality of the projecting ridges 61 is arranged along the circumferential direction, and the recessed grooves 62 are formed between the projecting ridges 61 that are adjacent to each other. Thus, the noise-reduction portion 60 has a structure in which the recessed grooves 62 and the projecting ridges 61 are alternately arranged. The ridge-line direction (longitudinal direction) of each projecting ridge 61 corresponds to the radial direction, and the groove longitudinal direction of each recessed groove 62 corresponds to the radial direction. In the noise-reduction portion 60, since the plurality of the projecting ridges 61 is arranged along the circumferential direction in this manner, the projecting ridges 61 and the recessed grooves 62 are alternately arranged such that the groove longitudinal direction of each recessed groove 62 corresponds to the radial direction.

This structure enables the noise-reduction portion 60 to have a function of reducing noise, and also enables grease charged in the bearing to flow along the recessed grooves 62 in the radial directions. This structure effectively contributes to lubrication of the rolling bearing 1 with the grease. Specifically, if annular projecting ridges (not depicted) are formed on the inner side surface 7a of the shield plate 7, the recessed grooves are also formed in an annular shape. In this case, grease trapped in the recessed grooves stays in the recessed grooves, and it is difficult for the grease to move toward the outer ring, which is less likely to contribute to lubrication of the bearing. In contrast, as in the structure depicted in FIG. 3, the groove longitudinal direction of each recessed groove 62 corresponds to the radial direction. This allows grease trapped in the recessed grooves 62 to easily flow toward the outer ring 3 (or the inner ring 2). Grease flowing to the outer ring 3 (or the inner ring 2) is used to lubricate the bearing. The groove longitudinal direction (the ridge-line direction of each projecting ridge 61) of each recessed groove 62 does not have to be identical to the radial direction, and may be inclined with respect to the radial direction.

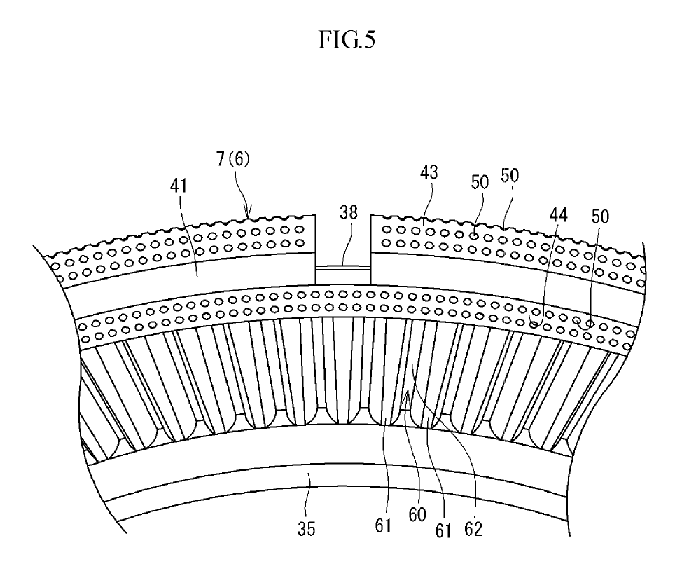

In rolling bearing 1 of the present embodiment, the attachment surfaces 43, 44 of the shield plate 7 that is in contact with the outer ring 3 are rough surfaces as depicted in FIG. 5. In the structure depicted in FIG. 5, on each of the first attachment surface 43 and the second attachment surface 44, multiple independent depressed portions 50 are formed, and thus the attachment surfaces 43, 44 are rough surfaces. The attachment surfaces 43, 44 are in contact with the groove inner peripheral surface 35 and the groove side surface 36 of the recessed groove 39 (see FIG. 2). Specifically, due to the depressed portions 50, not the entire surfaces of the attachment surfaces 43, 44 along the entire length in the circumferential direction, but portions of the surfaces thereof excluding the depressed portions 50 are in contact with the groove inner peripheral surface 35 and the groove side surface 36. At the notches 38 also, the shield plate 7 is not contact with the outer ring 3 (recessed groove 39). The depressed portions 50 and the notches 38 can reduce the contact area with the recessed groove 39 at the outer peripheral portion 41 of the shield plate 7 in comparison with the case where the entire surfaces along the entire length in the circumferential direction are in contact therewith.

As described above, each sealing device 6 of the present embodiment is formed of a ring body that is in contact with and attached to the outer ring 3. In the structure depicted in FIG. 1, the ring body is the annular shield plate 7. This shield plate 7 is made of resin, and is different in material from the outer ring 3 that is made of steel.

Furthermore, the attachment surfaces 43, 44 (see FIG. 4) of the shield plate 7 that are in contact with the recessed groove 39 of the outer ring 3 are rough surfaces. Thus, the vibration period (natural frequency) of the sealing device 6 that is the shield plate 7 is different from that of the outer ring 3. Consequently, noise caused by vibration of the outer ring 3 when the rolling bearing 1 rotates can be reduced by the presence of the shield plate 7. In other words, the shield plate 7 configured to prevent entry of foreign matter can have a damping effect of suppressing noise generation.

The following describes noise in the rolling bearing 1 (see FIG. 1). In the rolling bearing 1 that is rotating, vibrations (sound) generated at rolling contact portions between the raceway groove 21 of the inner ring 2 and the balls 4 and between the raceway groove 31 of the outer ring 3 and the balls 4, and at sliding contact portions between the cage 5 and the balls 4 vibrate the outer ring 3, and are transmitted outside the bearing. In addition, when sound caused by vibration of the outer ring 3 at its natural frequency is heard from the outer ring 3 regardless of the number of revolutions, the sound is noise to be suppressed. In view of this, in the present embodiment, the shield plates 7 having a natural frequency that is different from that of the outer ring 3 are fitted into the outer ring 3. This can suppress vibration of the outer ring 3 and reduce noise. If the shield plates 7 attached to the outer ring 3 are made of the same steel as the outer ring 3, the shield plates 7 and the outer ring 3 have the same Young's modulus. Thus, even when such shield plates 7 are brought into contact with and attached to the outer ring 3, (which may increase stiffness and reduce noise to some extent) the vibration period does not change, and noise reduction cannot be expected.

When the outer ring 3 and the shield plates 7 are in close contact with each other, vibrations (sound) can be easily transmitted from the outer ring 3 to the shield plates 7. In view of this, in order to prevent each shield plate 7 from vibrating and becoming a sound source, the surface (attachment surface 43, 44) of the outer peripheral portion 41 serving as a portion of the shield plate 7 to be attached to the outer ring 3 is made rough. Thus, even if vibrations attempt to be transmitted from the outer ring 3 to the shield plate 7, the contact area between the outer ring 3 and the shield plate 7 is smaller, which increases the vibration transfer resistance. This can prevent the shield plate 7 from vibrating and becoming a sound source. In other words, by reducing the contact area between the outer ring 3 and the shield plate 7, transmitted vibrations are reduced (vibration transfer resistance is increased), whereby the shield plate 7 is prevented from becoming a noise source.

Furthermore, in the present embodiment, as depicted in FIG. 5, on the outer peripheral portion 41 including the attachment surface 43 of each shield plate 7, the notches 38 are formed. Thus, the attachment surface 43 is divided into a plurality of portions. Since the notches 38 are formed on the shield plate 7 in this manner, vibration transfer paths from the outer ring 3 to the shield plate 7 are reduced and the shield plate 7 can be more effectively prevented from vibrating and becoming a noise source. As described above, with the structure of the present embodiment, vibration of the outer ring 3 is suppressed by the shield plates 7, and the attachment surfaces 43, 44 of the shield plates 7 to the outer ring 3 are made rough to make it difficult for vibrations to be transmitted from the outer ring 3 to the shield plates 7.

As described above, noise caused by vibration of the outer ring 3 can be reduced by the damping effect of the shield plates 7. Furthermore, noise generated inside the bearing by rotation of the bearing, i.e., vibrations (sound) generated at the rolling contact portions and the sliding contact portions, can be reduced by the noise-reduction portions 60.

In the present embodiment, in order to reduce noise generated in the rotating rolling bearing 1, the sealing devices 6 (shield plates 7) are utilized. This eliminates the need of additional members for noise reduction, thereby making it possible to reduce noise while suppressing cost increase as small as possible. Each shield plate 7 is formed by injection molding using a die. Thus, the noise-reduction portion 60 in each inner side surface 7a and the depressed portions 50 in the attachment surfaces 43, 44 can be easily formed by transferring shapes of an uneven waveform and multiple projecting portions formed on this die (not depicted). Specifically, in order to form the noise-reduction portion 60, part of the die for injection molding only needs to be formed in an uneven waveform. In order to make the attachment surfaces 43, 44 rough, the surface of other part of the die for injection molding only needs to be made rough.

In order for each shield plate 7 to have a function of restraining displacement (vibration) of the outer ring 3, it is preferable that the stiffness of the shield plate 7 be further increased. For this, the shield plate 7 may be made of resin (FRP) containing reinforced fiber such as glass fiber. In order to further enhance the function of stopping displacement (vibration) of the outer ring 3 by the shield plate 7, ceramic may be used as the material of the shield plate 7.

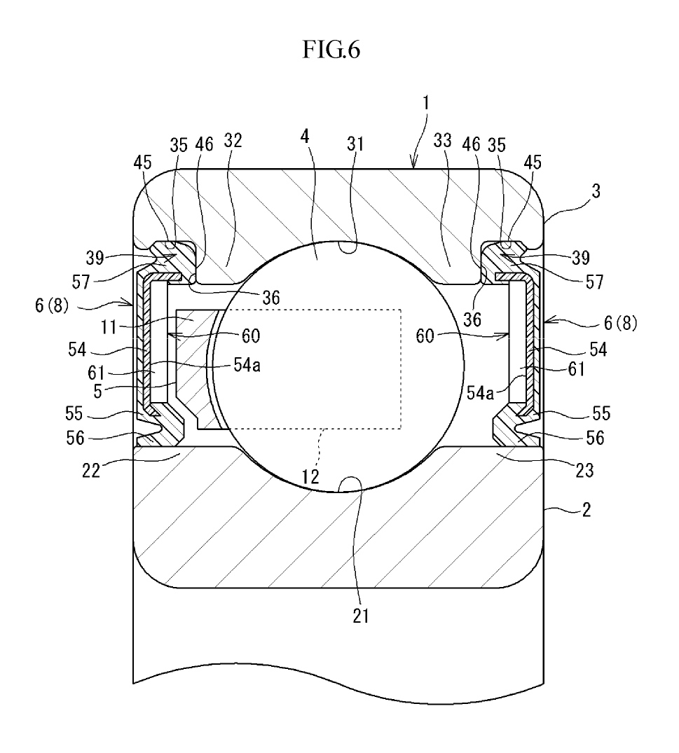

The ring body forming the sealing device 6 may be the shield plate 7 made of one kind of material (synthetic resin) as in the embodiment described above. Alternatively, the ring body may be made of a plurality of kinds of materials. Specifically, as depicted in FIG. 6, the ring body forming each sealing device 6 attached to the corresponding recessed groove 39 of the outer ring 3 may be an annular seal member 8 including a resin portion and a rubber portion. This seal member 8 includes an annular core member 54 made of resin and a rubber member 55 that is fixed to this core member 54. When the ring body forming the sealing device 6 is made of a plurality of kinds of materials as in the seal member 8, the materials are each different from the material of the outer ring 3.

The rubber member 55 included in each seal member 8 is bonded to the core member 54. This seal member 8 has, at its inner peripheral portion, a lip portion 56 that can be in sliding contact with the inner ring 2 (shoulder portion 22, 23). The seal member 8 prevents foreign matter from entering inside the bearing. The core member 54 included in each seal member 8 is made of resin (synthetic resin) such as polyphenylene sulfide resin or polyamide resin (PA66), and is produced by injection molding.

When each sealing device 6 is the seal member 8 as depicted in FIG. 6, the noise-reduction portion 60 is formed on a bearing inner-side surface (inner side surface) 54a of the corresponding core member 54 which is closer to the balls 4. The structure of this noise-reduction portion 60 is the same as the structure of the embodiment depicted in FIG. 3 and FIG. 4, and the function is also the same, and thus description thereof is omitted.

Furthermore, also when the sealing device 6 is the seal member 8 as depicted in FIG. 6, the attachment surfaces of the seal member 8 that are in contact with the outer ring 3 are rough surfaces. In the embodiment depicted in FIG. 6, the attachment surfaces of the seal member 8 that are in contact with the recessed groove 39 of the outer ring 3 are surfaces (45, 46) of the rubber member 55. Specifically, an outer peripheral portion 57 of the rubber member 55 has two attachment surfaces 45, 46. In a state in which the seal member 8 is attached to the recessed groove 39, the first attachment surface 45 is in contact with the groove inner peripheral surface 35 of the recessed groove 39, and the second attachment surface 46 is in contact with the groove side surface 36 of the recessed groove 39. These attachment surfaces 45, 46 are rough surfaces. In a specific example of the rough surfaces, in the same manner as in the structure depicted in FIG. 5, multiple depressed portions are formed on the attachment surfaces 45, 46. These depressed portions are formed by transferring projecting portions of a die when the rubber member 55 is molded. The depressed portions can make part of the outer peripheral portion 57 of the rubber member 55 rough. The comparison of the rolling bearing 1 depicted in FIG. 6 with the rolling bearing 1 depicted in FIG. 1 shows that the structure of the sealing devices 6 is different, but the other matters are the same, and therefore description of the same points is omitted.

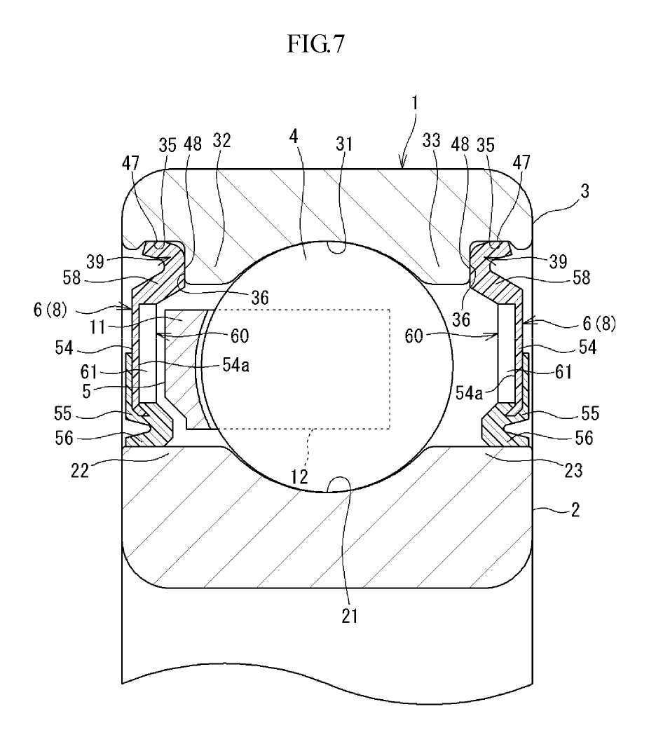

FIG. 7 is a sectional view illustrating a modification of the rolling bearing 1 depicted in FIG. 6. The comparison of the rolling bearing 1 depicted in FIG. 7 with the rolling bearing 1 depicted in FIG. 6 (FIG. 1) shows that the structure of the sealing devices 6 is different, but the other matters are the same, and therefore description of the same points is omitted. Each sealing device 6 depicted in FIG. 7 is the seal member 8 similar to that in FIG. 6. An outer peripheral portion 58 of the seal member 8 that is brought into contact with and attached to the recessed groove 39 of the outer ring 3 is part of the core member 54. Specifically, the core member 54 is attached to the outer ring 3 such that the outer peripheral portion 58 of the core member 54 that is made of resin is in contact with the outer ring 3. A rubber member 55 is provided only to a radially inner portion of the core member 54.

In the embodiment depicted in FIG. 7, the noise-reduction portion 60 is formed on the bearing inner-side surface (inner side surface) 54a of the core member 54 which is closer to the balls 4. The structure of this noise-reduction portion 60 is the same as the structure of the embodiment depicted in FIG. 3 and FIG. 4, and the function is also the same, and thus description thereof is omitted.

Furthermore, in the embodiment depicted in FIG. 7, the attachment surfaces of the seal member 8 that are in contact with the outer ring 3 are rough surfaces. Specifically, the outer peripheral portion 58 of the core member 54 has two attachment surfaces 47, 48. In a state in which the seal member 8 is attached to the recessed groove 39, the first attachment surface 47 is in contact with the groove inner peripheral surface 35 of the recessed groove 39. The second attachment surface 48 is in contact with the groove side surface 36 of the recessed groove 39. These attachment surfaces 47, 48 are rough surfaces. In a specific example of the rough surfaces, in the same manner as in the structure depicted in FIG. 5, multiple depressed portions are formed on the attachment surfaces 47, 48. These depressed portions are formed by transferring projecting portions of a die when the core member 54 is injection-molded. The depressed portions can make part of the outer peripheral portion 58 of the core member 54 rough.

In the embodiment of FIG. 6 and FIG. 7, the core member 54 is made of resin, but only needs to be made of a material different from the material of the outer ring 3, and may be made of ceramic.

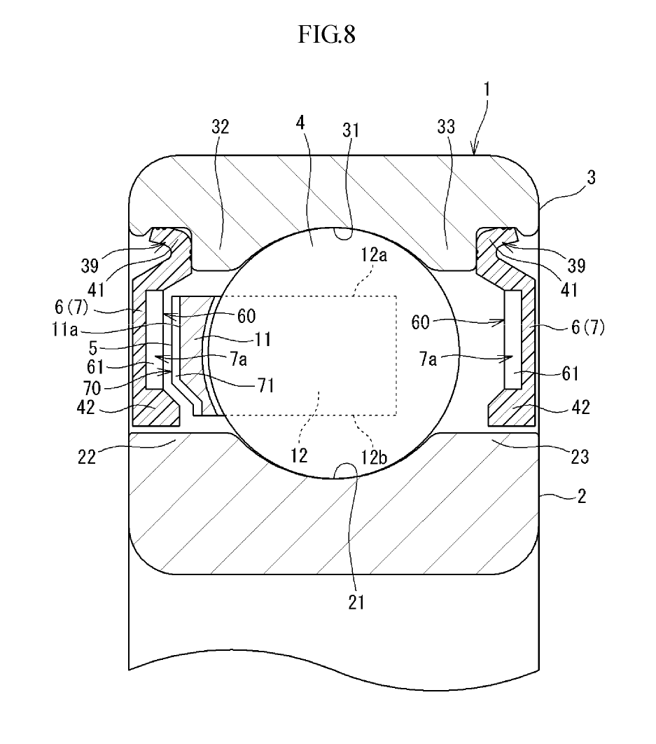

FIG. 8 is a sectional view illustrating a rolling bearing according to still another embodiment. The rolling bearing 1 depicted in FIG. 8 is the same as the rolling bearing 1 depicted in FIG. 1 except that the structure of the cage 5 is different, and description of the same points is omitted.

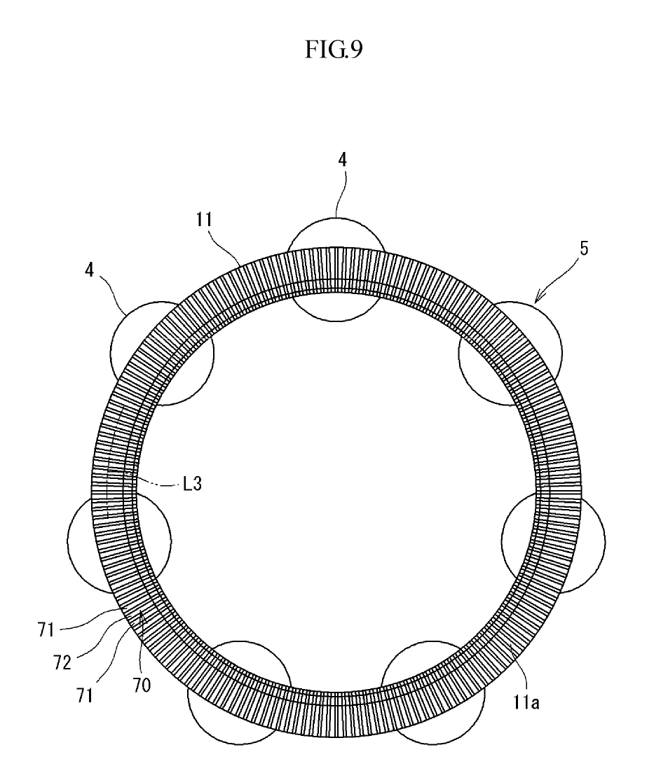

The cage 5 included in the rolling bearing 1 depicted in FIG. 8 includes the annular portion 11 and the cage bar portions 12 that extend from this annular portion 11 in the axial direction. A noise-reduction portion 70 is formed on the annular portion 11. In the rolling bearing 1 depicted in FIG. 8, the noise-reduction portion 70 is formed on a surface 11a of the annular portion 11 that faces outward in the axial direction. FIG. 9 is a diagram of the cage 5 holding the balls 4 when viewed from the axial direction. The cross-sectional shape of the noise-reduction portion 70 taken along the virtual line L3 along the circumferential direction in FIG. 9 is the same as the cross-sectional shape (on the surface 7a side) depicted in FIG. 4. Specifically, the surface 11 a of the annular portion 11 that faces outward in the axial direction has an uneven shape, and this uneven shape attenuates sound inside the bearing. The structure of the noise-reduction portion 70 is the same as that of the noise-reduction portion 60 of the sealing device 6 depicted in FIG. 3 and FIG. 4, and the function is also the same.

As depicted in FIG. 9, in this noise-reduction portion 70, a plurality of projecting ridges 71 is arranged along the circumferential direction, and recessed grooves 72 are formed between the projecting ridges 71 that are adjacent to each other. Thus, the noise-reduction portion 70 has a structure in which the recessed grooves 72 and the projecting ridges 71 are alternately arranged. The ridge-line direction (longitudinal direction) of each projecting ridge 71 corresponds to the radial direction, and the groove longitudinal direction of each recessed groove 72 corresponds to the radial direction. In the noise-reduction portion 70, since the plurality of the projecting ridges 71 is arranged along the circumferential direction in this manner, the projecting ridges 71 and the recessed grooves 72 are alternately arranged such that the groove longitudinal direction corresponds to the radial direction.

This structure enables the noise-reduction portion 70 formed on the surface 11a of the cage 5 that faces outward in the axial direction to have a function of reducing noise, and also enables grease charged in the bearing to flow along the recessed grooves 72 in the radial directions, in the same manner as the case where the noise-reduction portion 60 is formed on the shield plate 7 (sealing device 6) (see FIG. 3).

This structure effectively contributes to lubrication of the rolling bearing 1 with the grease. The groove longitudinal direction (the ridge-line direction of each projecting ridge 71) of each recessed groove 72 does not have to be identical to the radial direction, and may be inclined with respect to the radial direction.

The cage 5 depicted in FIG. 8 has the annular portion 11 only on one side of the bearing 1 in the axial direction. However, although not depicted, the cage 5 may have a second annular portion on the other side of the bearing 1 in the axial direction, and a pair of the annular portions (11) may be coupled together by the cage bar portions (12). In this case, on the surface (11a) of each of the annular portions (11) that faces outward in the axial direction, the noise-reduction portion (70) may be formed. The noise-reduction portion 70 may be formed on a surface other than the surface 11a of the annular portion 11 that faces outward in the radial direction. For example, the noise-reduction portion may be formed on at least one of an inner peripheral surface and an outer peripheral surface of the annular portion 11 (in addition to the surface 11a). Alternatively, the noise-reduction portion may be formed on at least one of a radially outer surface 12a and a radially inner surface 12b of each cage bar portion 12 (see FIG. 8). Providing the noise-reduction portions (70) to the cage 5 as described above enables areas near the rolling contact portions and the sliding contact portions to have a function of reducing noise.

The cage 5 provided with the noise-reduction portion 70 depicted in FIG. 8 may be used as the cage of the rolling bearing 1 depicted in FIG. 1, FIG. 6, or FIG. 7. In other words, the noise-reduction portion 60 (70) that attenuates sound inside the bearing may be formed on at least one of a surface of the cage 5 and a bearing inner-side surface of each sealing device 6. This enables the noise-reduction portion 60 (70) to reduce sound (radiated sound) generated by rolling of the balls 4 on the raceway grooves 21, 31 and sound generated by sliding contact between the cage 5 and the balls 4 when the rolling bearing 1 rotates, and thus noise transmitted from the outer ring 3 to the outside of the bearing can be reduced. In order to reduce noise generated in the rolling bearing 1, at least one of the cage 5 and each sealing device 6 is utilized. This eliminates the need of additional members for noise reduction, thereby enabling noise reduction of the rolling bearing 1 while suppressing cost increase as small as possible.

With respect to each sealing device 6, the shield plate and the core member of the seal member are made of resin (or ceramic) in the rolling bearings 1 of the respective embodiments described above. This enables weight reduction of the rolling bearings 1 in comparison with the case where the shield plate and the core member are made of steel.

The embodiments disclosed in the foregoing are merely examples in all respects, and are not limiting. Specifically, the rolling bearing of the present invention is not limited to the embodiments depicted in the drawings, and may be structured in a different manner within the scope of the present invention. For example, the embodiments have been described in which each noise-reduction portion 60 (70) has a texture structure for noise reduction (sound adsorption) having an uneven waveform formed on part of the sealing device 6 (part of the cage 5). However, the structure of the noise-reduction portion may be a structure other than this, and may be, for example, a texture structure for noise reduction (sound adsorption) having independent protrusions or depressions.

The embodiments have been described in which, in order to make the attachment surface of the shield plate 7 or the seal member 8 rough, which is brought into contact with and attached to the outer ring 3, multiple depressed portions 50 are formed as depicted in FIG. 5. However, the structure for making the surfaces rough may be a structure other than the texture structure having the depressed portions 50, and may be a texture structure having an uneven waveform, for example. Specifically, the structure only needs to be a structure (texture structure) that reduces the contact area between the recessed groove 39 and the attachment surface of the shield plate 7 or the seal member 8.

The embodiments have been described in which the rolling elements are the balls 4 interposed between the inner ring 2 and the outer ring 3. However, the rolling elements may be cylindrical rollers or tapered rollers, for example.

The present invention enables noise reduction of the rolling bearing while suppressing cost increase as small as possible.

What is claimed is:

1. A rolling bearing comprising:
an inner ring;
an outer ring:
a plurality of rolling elements interposed between the inner ring and the outer ring;
a cage that holds the rolling elements; and
a sealing device that is attached to each of opposite sides of the outer ring in an axial direction to prevent foreign matter from entering inside the bearing, wherein
a noise-reduction portion that attenuates sound inside the bearing is formed on at least one of a surface of the cage and a bearing inner-side surface of the sealing device.

2. The rolling bearing according to claim 1, wherein
the sealing device is formed of a ring body that is made of a material different from a material of the outer ring and is in contact with and attached to the outer ring.

3. The rolling bearing according to claim 1, wherein
the sealing device is an annular shield plate made of resin or ceramic, and the noise-reduction portion is formed on a bearing inner-side surface of the shield plate.

4. The rolling bearing according to claim 1, wherein
the sealing device is a seal member that includes an annular core member made of resin or ceramic and a rubber member having a lip portion capable of being in sliding contact with the inner ring and fixed to the core member, and the noise-reduction portion is formed on a bearing inner-side surface of the core member.

5. The rolling bearing according to claim 1, wherein
the cage includes an annular portion and a cage bar portion extending from the annular portion in the axial direction, and the noise-reduction portion is formed on the annular portion or the cage bar portion.

6. The rolling bearing according to claim 1,
wherein the noise-reduction portion has a structure in which a plurality of projecting ridges is arranged in a circumferential direction, whereby the projecting ridges and recessed grooves are alternately arranged such that a groove longitudinal direction corresponds to a radial direction or is inclined with respect to the radial direction.

7. The rolling bearing according to claim 2,
wherein the noise-reduction portion has a structure in which a plurality of projecting ridges is arranged in a circumferential direction, whereby the projecting ridges and recessed grooves are alternately arranged such that a groove longitudinal direction corresponds to a radial direction or is inclined with respect to the radial direction.

8. The rolling bearing according to claim 3,
wherein the noise-reduction portion has a structure in which a plurality of projecting ridges is arranged in a circumferential direction, whereby the projecting ridges and recessed grooves are alternately arranged such that a groove longitudinal direction corresponds to a radial direction or is inclined with respect to the radial direction.

9. The rolling bearing according to claim 4,
wherein the noise-reduction portion has a structure in which a plurality of projecting ridges is arranged in a circumferential direction, whereby the projecting ridges and recessed grooves are alternately arranged such that a groove longitudinal direction corresponds to a radial direction or is inclined with respect to the radial direction.

10. The rolling bearing according to claim 5,
wherein the noise-reduction portion has a structure in which a plurality of projecting ridges is arranged in a circumferential direction, whereby the projecting ridges and recessed grooves are alternately arranged such that a groove longitudinal direction corresponds to a radial direction or is inclined with respect to the radial direction.
